(19) United States
(12) Patent Application Publication
(10) Pub. No.: US 2010/0054632 A1
(43) Pub. Date: Mar. 4, 2010

(54) Method and Apparatus to Facilitate Removing a Visual Distraction From an Image Being Captured

(75) Inventors: Mark A. McCormick, Chicago, IL (US); Gregory J. Dunn, Arlington Heights, IL (US); Gary W. Grube, Barrington, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/202,840

(22) Filed: Sep. 2, 2008

(51) Int. Cl. G06K 9/03

(52) U.S. Cl. 382/311

(57) ABSTRACT

One provides (101) a captured image of a real-world setting that comprises both target content and at least one visual distraction. One also provides (102), via a display, information regarding selectable elements of the captured image as a function of the relative positions (such as relative depth) of the selectable elements with respect to one another. An end user (via an end-user interface) can select (103) at least one visual distraction as a selected element. Additional image content from the real-world setting can then be accumulated (105) for a portion of the target content as corresponds to the selected element. This additional image content is then aggregated (106) with previously obtained image content for the target content to facilitate the provision of an image of the real-world setting that comprises the target content in the absence of the at least one visual distraction.

### TECHNICAL FIELD

This invention relates generally to image capturing.

### BACKGROUND

Various mechanisms are known that facilitate capturing a real-world image. Recently, digital approaches in this regard have proven both useful and popular. Capturing real-world images using a digital platform, for example, permits the captured image to be viewed and assessed immediately. This, in turn, permits the end user to determine whether the real-world subject has been adequately captured in accordance with the end user's intent and wishes.

Unfortunately, such capabilities cannot change certain aspects of the application setting itself. For example, in many cases, the photographer will find that any number of visual distractions are present in the real-world setting that detract from the real-world subject in the resultant captured image. As but one simple example in this regard, other persons are often present in the foreground between the image-capture device and the real-world subject. These other persons often occlude portions of the subject and render those portions of the subject non-visible in the resultant captured image.

Various post-capture processing techniques are available to attempt to ameliorate such circumstances. By one approach, the end user can tediously copy other portions of the captured image that are similar in appearance to an occluded portion and paste those portions within the occluded area. By another approach, the editing software can attempt to interpolate the contents of occluded areas as a function of the contents of the non-occluded areas. In some, but not all, cases these approaches can be successfully applied. In most cases, however, such approaches can be tedious to employ and can require that the end user undergo considerable training in order to develop the requisite skills.

### BRIEF DESCRIPTION OF THE DRAWINGS

The above concerns are at least partially met through provision of the method and apparatus to facilitate removing a visual distraction from an image being captured described in the following detailed description, particularly when studied in conjunction with the drawings, wherein:

FIG. 1 is a flow diagram as configured in accordance with various embodiments of the invention;

FIG. 2 is a perspective schematic view as configured in accordance with various embodiments of the invention;

FIG. 3 is a front elevational schematic view as configured in accordance with various embodiments of the invention;

FIG. 4 is a perspective schematic view as configured in accordance with various embodiments of the invention;

FIG. 5 is a front elevational schematic view as configured in accordance with various embodiments of the invention;

FIG. 6 is a perspective schematic view as configured in accordance with various embodiments of the invention;

FIG. 7 is a front elevational schematic view as configured in accordance with various embodiments of the invention;

FIG. 8 is a front elevational schematic view as configured in accordance with various embodiments of the invention;

FIG. 9 is a front elevational schematic view as configured in accordance with various embodiments of the invention;

FIG. 10 is a front elevational schematic view as configured in accordance with various embodiments of the invention;

FIG. 11 is a perspective schematic view as configured in accordance with various embodiments of the invention;

FIG. 12 is a front elevational schematic view as configured in accordance with various embodiments of the invention;

FIG. 13 is a front elevational schematic view as configured in accordance with various embodiments of the invention; and

FIG. 14 is a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one provides a captured image of a real-world setting that comprises both target content and at least one visual distraction. One also provides, via a display, information regarding selectable elements of the captured image as a function of the relative positions (such as relative depth) of the selectable elements with respect to one another. An end user (via an end-user interface) can select at least one visual distraction as a selected element. Additional image content from the real-world setting can then be accumulated for a portion of the target content as corresponds to the selected element. This additional image content is then aggregated with previously obtained image content for the target content to facilitate the provision of an image of the real-world setting that comprises the target content in the absence of any significant portion of the at least one visual distraction.

By one approach, this captured image comprises a depth image having pixels that have depth information associated therewith. The aforementioned information regarding selectable elements can be portrayed, by one approach, through selectively rendering presently selectable elements of the captured image in a manner that is different from the rendering format that is applied to presently non-selectable elements. If desired, this can include the use of a translucent membrane having a particular relative location within the field of depth for the captured image.

With a method so configured, an end user with very little training can quickly learn to select undesired content within his field of view when capturing an image of interest. Very little else is then required on the user's part. The image-capture platform can then continue to gather information from the real-world setting to gather image information regarding, for example, selected portions that were occluded in the original image. While a complete simultaneously clear and open shot of the real-world subject may never occur, these teachings will nevertheless permit, in many application settings and without movement on the part of the end user, a complete, unobstructed view of the subject.

Those skilled in the art will recognize and appreciate that these teachings are readily employed with many existing image-capture platforms and can be successfully used by end users having very little training or accumulated skills in these regards. These teachings can be facilitated in very economical ways and are readily scaled and leveraged to accommodate a wide variety of image-capture platforms, processing systems, and application settings.

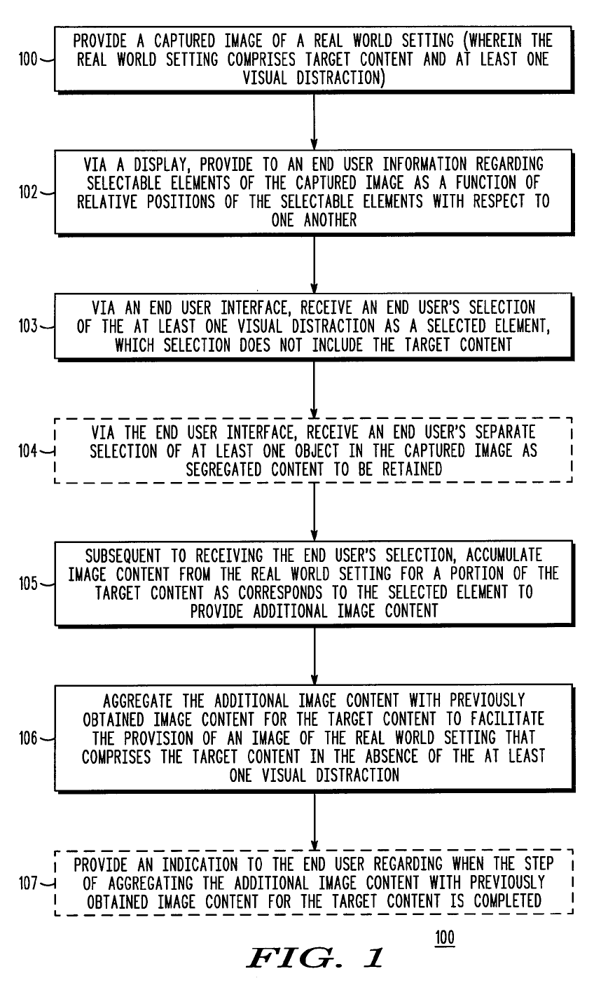

These and other benefits may become clearer upon making a thorough review and study of the following detailed description. Referring now to the drawings, and in particular to FIG. 1, an illustrative process that is compatible with many of these teachings will now be presented.

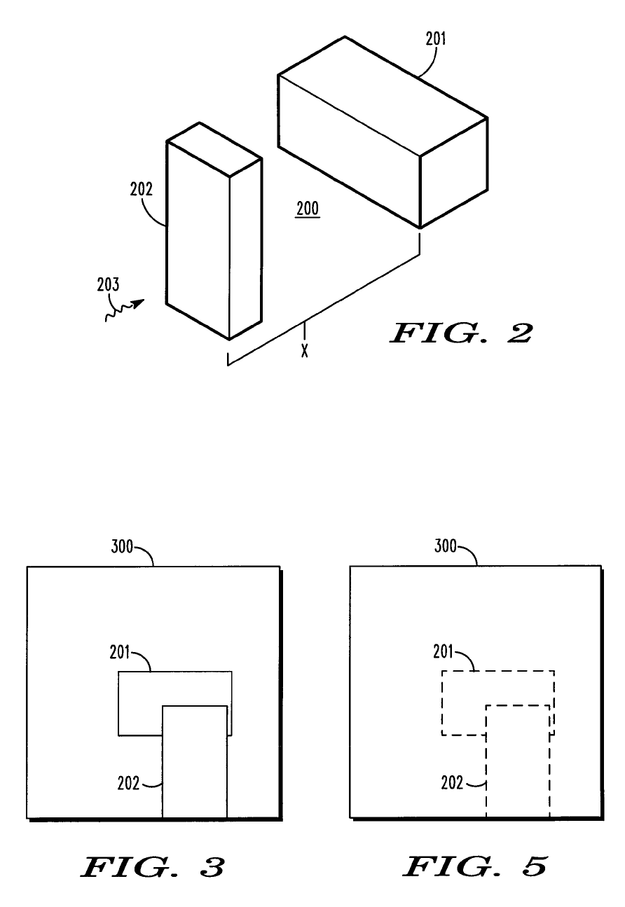

This process 100 provides for provision 101 of a captured image of a real-world setting that includes both target content and at least one visual distraction. This target content, as well as the visual distraction, can vary widely with respect to the application setting. By one illustrative approach as shown in FIG. 2, and without intending any limitations in this particular regard, this target content 201 can comprise a background element. The visual distraction 202, in turn, can comprise a foreground element in the real-world setting 200 as viewed from a particular point of view 203. In such a case, the target content 201 and the visual distraction 202 (comprised, for example, of a real-world object) are separated from one another by a distance X (where X has a value that will vary, and sometimes considerably, from one real-world setting to another). In this illustrative example, and referring now momentarily to FIG. 3, a captured (or capturable) image display 300 of this real-world setting 200, from the aforementioned point of view 203, will provide only a partial view of the target content 201 due to the occluding nature of the visual distraction 202.

Referring again to FIG. 1, this process 100, via a corresponding display, then provides 102 to an end user information regarding selectable elements of this captured image as a function of relative positions of the selectable elements with respect to one another. For example, in the illustrative example provided above, the difference in depth X between the target content 201 and the visual distraction 202 can serve as a useful differentiator in this regard. With this in mind, the aforementioned captured image can comprise a depth image that comprises pixels that not only have corresponding intensity and color information but which also have depth information corresponding thereto.

Those skilled in the art will recognize that images having pixels with corresponding depth information are known in the art. By one approach, digital stereoscopic images comprise such an image and will therefore suffice for the present purposes in this regard. Such images are often created using, for example, two image-capture inputs in a simultaneous manner or one image-capture input that captures at least two views of the real-world setting from different locations at different points in time. As the present teachings are not overly sensitive to any particular selection in this regard, for the sake of brevity and for the purpose of clarity, further elaboration in this regard will not be provided here. Regardless of the depth-imaging technique used, it is understood in the art that even an optimized technique may produce some erroneous depth information, particularly in pixels that straddle an object perimeter, but also in pixels corresponding to surfaces or lighting conditions that challenge the depth-imaging technology or combination of depth-imaging technologies being used. Accordingly, it is understood that image segmentation according to depth information, while ideally error-free, is in practice typically only free of a significant number of incorrectly categorized pixels. The present teachings will be understood and interpreted with that understanding in place.

By one approach, this step of providing information to an end user regarding selectable elements can comprise rendering presently selectable elements of the captured image in a manner that is different from a rendering format that is applied to presently non-selectable elements of the captured image. This can comprise, as but one illustrative example in this regard, rendering the presently selectable elements to appear as they appear in the captured image (that is, without further affectation, emphasis, or the like) and using a rendering format for the presently non-selectable elements that is different from the captured image. The latter might comprise, for example, rendering the non-selectable elements using a grayscale color approach instead of a full-color approach, using a reduced (or increased) hue or saturation setting, using a reduced (or increased) brightness or contrast setting, and so forth.

By one approach, this alternative rendering approach can comprise the use of a translucent membrane. Such a translucent membrane will be understood to comprise a virtual element through which an end user will view background elements (that is, elements that are further in depth than the depth as corresponds to a present depth setting of the translucent membrane). The visual effect imparted by this translucent membrane can relate, for example, to the attenuation of one or more visual characteristics including brightness, contrast, color, hue, saturation, and so forth.

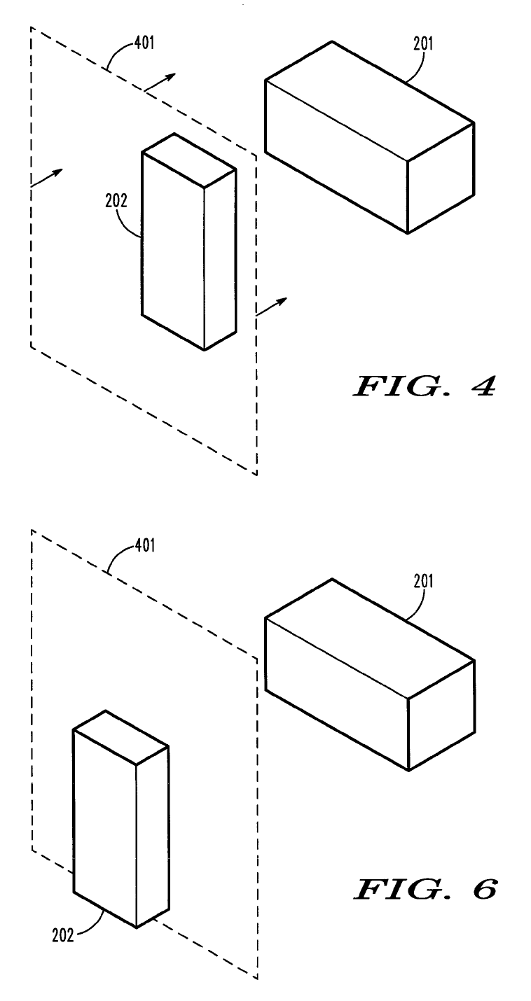

Referring momentarily to FIG. 4, this step of displaying information regarding selectable elements can begin with this translucent membrane 401 being at some predetermined initial depth such as, in this example, 0.0 meters (that is, at the image-capture platform itself). In such a case, and referring now momentarily to FIG. 5, all of the elements in the captured image, including the target content 201 and the visual distraction 202, are viewed through the translucent membrane and hence are rendered in the alternative format of choice.

Referring again to FIG. 1, this process 100 then provides for receiving 103, via an end-user interface such as a scroll wheel, a touch screen, or the like, an end user's selection of the at least one visual distraction as a selected element (where presumably, at least for the sake of this example, this selection does not include the target content). With reference now to FIG. 6, this can comprise, in the present example, moving the translucent membrane 401 outwardly towards the target content 201 until the translucent membrane 401 has a relative depth that is between the target content 201 and the visual distraction 202. So disposed, and referring now to FIG. 7, the display 300 being provided to the end user will continue to depict the target content 201 in a visually muted fashion, while the visual distraction 202 will now be rendered normally.

Those skilled in the art will recognize and appreciate that such a process 100 provides for a highly intuitive, yet highly effective, mechanism by which even a relatively untrained and unskilled end user can isolate and identify a visual distraction in a real-world field of view. The aforementioned end-user interface can be readily manipulated by the end user to move this translucent membrane deeper, or less deep, into the field of view to select, or unselect, various elements of the image as a function, in this example, of their relative depth.

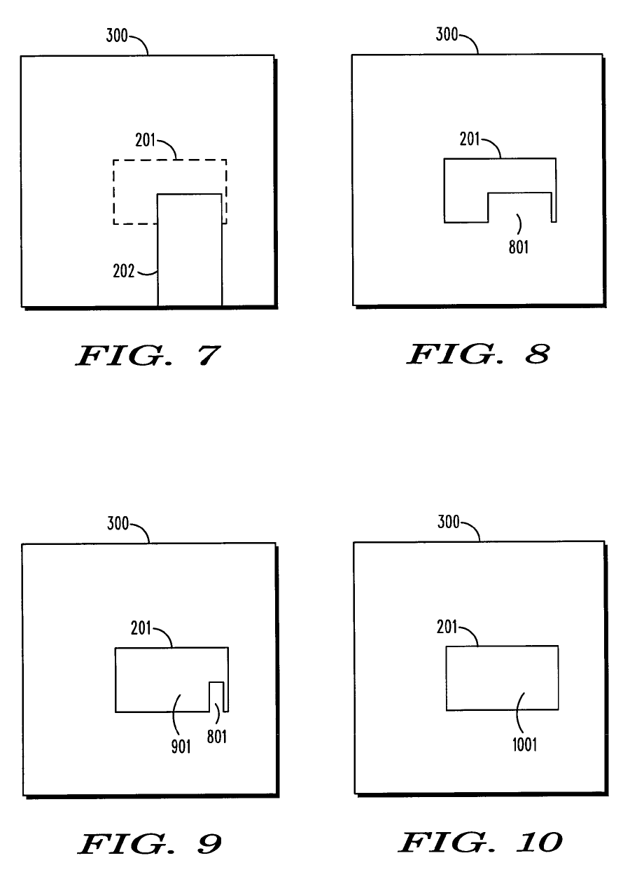

Subsequent to establishing this selection (and ignoring for the moment step 104 which is discussed further below where appropriate), and referring again to FIG. 1, this process 100 now accumulates 105 image content from the real-world setting for that portion of the target content which corresponds to the selected element to provide corresponding additional image content. To illustrate this concept, FIG. 8 presents the target content 201 having a portion 801 that is lacking target content information due to having been occluded previously by the visual distraction (which is no longer specifically shown in this rendering). Presuming for the sake of illustration that the visual distraction now moves towards the right, and referring now to FIG. 9, missing sections 901 of this portion 801 can be captured. In addition to leaving the image capture platform in a fixed position and accumulating the desired content as the target content and/or the visual distraction(s) assume different relative physical arrangements with respect to one another, these teachings will also accommodate, if desired, accumulating 105 this image content by capturing image content from at least two different relative physical arrangements of the image-capture platform itself as is used to capture the image of the real-world setting.

This subsequent accumulation step can continue, if desired, until the missing portion 801 is completely captured. At this point, and referring again to FIG. 1 as well as FIG. 10, this process 100 can serve to aggregate 106 the additional image content with the previously obtained image content for the target content 201 to facilitate the provision of an image of the real-world setting that presents the target content in the absence of any significant portion of the visual distraction as denoted by reference numeral 1001. (Those skilled in the art will recognize and accept that what constitutes a “significant portion” can vary with respect to the needs and expectations of a given end user and can also vary with respect to the application setting, the limitations and/or capabilities of the image capture platform, and so forth. Generally speaking, however, a “significant portion” will typically comprise, for example, something in the range of 90% of the visual distraction to something that is nearly, but not quite, the entire visual distraction.) This resultant image can then be permanently stored, forwarded, or otherwise handled in accordance with the end user's wishes.

By one approach, these accumulation and aggregation activities can be separate steps. By another approach, the newly gained data can be aggregated with previously obtained information even prior to all of the target content information having been so accumulated.

This process 100 will also accommodate various approaches to how these steps are displayed, or not displayed, to the end user during the accumulation activity. For example, if desired, this process 100 will readily accommodate displaying a present incomplete aggregation result that does not comprise a complete result for the target content while accumulating the image content from the real-world setting for the portion of the target content that corresponds to the selected element. By one approach, this ongoing accumulation/aggregation result can be more-or-less continuous or can, if desired, comprise a periodically updated result (such as, for example, once every five seconds, every fifteen seconds, once per minute, or once per such other increment of time as may be desired).

By one approach, this process 100 can continue until all information for the target content has been accumulated. If desired, however, this process 100 will also accommodate providing the end user with an opportunity to accept a present aggregation result (which is incomplete) and to terminate further accumulation of the image content from the real-world setting. Such an approach may well suit, for example, a situation where portions of the target content for which subsequent content has not yet been accumulated are unimportant to the end user. It would also be possible, alone or in conjunction with the approach just mentioned, to automatically conclude the information accumulation activity at the expiration of a given amount of time (such as 1 second, 10 seconds, 1 minute, 5 minutes, or such other period of time as might be useful in a given application setting) regardless of whether the accumulation process has been completed.

This process 100 will also accommodate use of content interpolation techniques if so desired. Various such techniques are known in the art and others are likely to be developed in the future. By one approach, for example, this process 100 can further comprise displaying (either automatically or upon being called up by the end user) a present aggregation result that also includes interpolated content to substitute for presently uncaptured image content from the real-world setting for the portion of the target content as corresponds to the selected element. In some cases, for example, the interpolated result may be sufficient for the end user's purposes. In such a case this process 100 can permit the end user to conclude the data accumulation process and to accept a resultant image that contains at least some interpolated content and potentially some amount of subsequently accumulated content in addition to the originally captured content.

In the examples provided above, these teachings were applied to remove a foreground element from a view of a given background element. Those skilled in the art will recognize and understand, however, that these teachings can be applied in favor of other application settings as well. For example, with reference to FIG. 11, a given end user may wish to have an image of a real-world setting that features desired background content 201, undesired middleground content 1101 and 1102, and a desired foreground element 1 103. In such a case, and referring again to FIG. 1, this process 100 will optionally accommodate receiving 104 (again, via the aforementioned end-user interface) an end user's separate selection of at least one object (such as the aforementioned illustrative desired foreground element 1103) as segregated content to be retained.

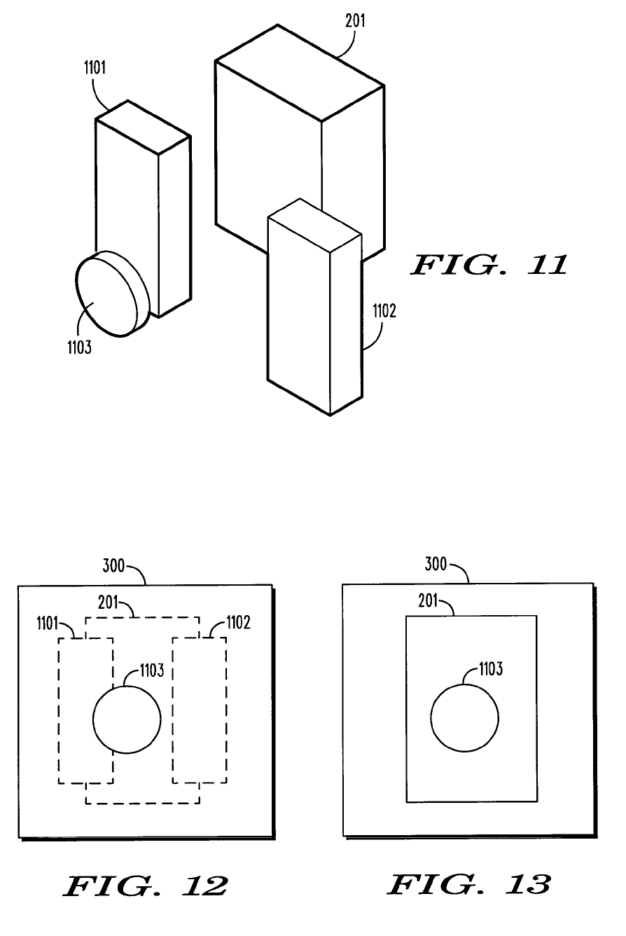

This can be done as described above with respect to selected visual distractions. For example, the end user can manipulate the aforementioned translucent membrane to select the desired foreground element 1103 as shown in FIG. 12. As illustrated, the selection of this foreground element 1103 is exemplified by the difference in rendering formats between the selected content and the unselected content that is being “viewed” through the translucent membrane. In this case, however, the selected content is preserved rather than effectively discarded in order to permit a later aggregation of that selected content with the fully captured background content.

This process 100 can then continue as described above. In particular, the end user can select the visual distractions 1101 and 1102 and then permit the process 100 to accumulate the previously occluded information for the target content 201. Upon completing this activity as described above, the aforementioned step of aggregating the desired content can then further comprise combining the previously selected and segregated content 1103 with the now-fully captured target content 201 as illustrated in FIG. 13. Such an approach could be used, for example, to capture a digital image of a friend (the desired segregated content) standing in front of a famous landmark (such as the Grand Canyon in the United States) in the absence of numerous other sightseers (the visual distractions) who are also in the real-world setting.

In the examples provided above, the translucent membrane resided in a plane positioned perpendicular to the field of view of the image-capture platform. Other possibilities exist in this regard, however. Such a membrane could be tilted or angled as desired. A corresponding amount of tilt or angle of this membrane, in turn, can comprise an adjustable parameter that the end user can manipulate if so desired. These teachings will also accommodate using more than one such translucent membrane. For example, by one approach, two such membranes which meet at a ninety degree angle could be employed to meet particular needs in a particular application setting. As another example, four such membranes could be arranged to form a rectangle or box that encapsulates a given object of interest. Numerous other possibilities are also available (for example, all or a part of such a membrane could be curved or have an irregularly-defined form factor). These teachings should be generally viewed as being inclusive of such various approaches.

If desired, and referring again to FIG. 1, this process 100 will also optionally provide for providing 107 an indication to an end user regarding when the step of aggregating the additional image content with previously obtained image content for the target content is concluded. This indication can vary with the needs and/or opportunities as tend to characterize a given application setting. By one approach this indication can comprise an audible alert of choice. By another approach, this indication can comprise a visual signal of choice. By yet another approach, this indication can comprise a haptic sensation such as a vibratory effect of choice.

In the examples provided above, it is presumed that the image-capture platform remains stationary throughout the described process. It will be understood, however, that these teachings can be employed with a non-stationary image-capture platform. By one approach, for example, the image-capture platform can be purposefully moved during the additional content accumulation step in order to gain access to target content information that might otherwise remain permanently occluded by a stationary occluding foreground element. As another example in this regard, the image-capture platform might be subject to slight movement (such as when the image-capture platform resides within a handheld cellular telephone) often denoted as jitter in the art. In this case, various known image stabilization techniques can be employed as desired to compensate for such movement. It will be further understood that the image-capture platform may capture occluded target content even if the platform and the occluding foreground element both remain stationary, if the image-capture platform comprises two or more image-capture inputs, such as in a stereoscopic or multiscopic imaging system. For example, a stationary three-camera platform could be used to capture an unoccluded image of target content through a chain-link fence, depending upon the separation of the lenses, the distances from the platform to the occluding fence and target content, and the dimensions and geometry of the chain link.

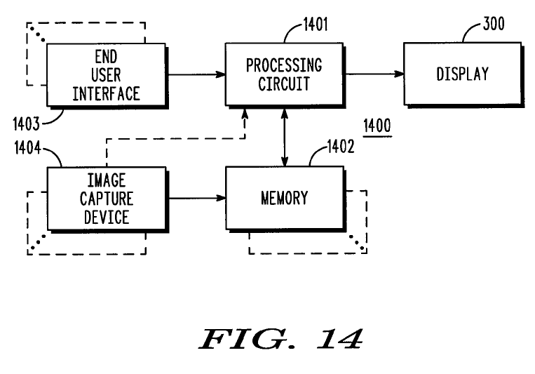

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 14, an illustrative approach to such a platform will now be provided.

This apparatus 1400 can comprise a processing circuit 1401 that operably couples to the aforementioned display 300 as well as memory 1402 and the aforementioned end-user interface 1403. This memory 1402 can serve to store the aforementioned captured image of the real-world setting of interest as well as the accumulated target content information, retained image content as described above, and aggregated resultant images as desired. Those skilled in the art will recognize that such a memory can comprise a single physical element or can comprise a plurality of physical components as desired. The end-user interface 1403 can comprise any of a wide variety of known interface mechanisms including, but not limited to, touch screens, rotating knobs, faders, scroll wheels, cursor movement and/or selection tools, and so forth.

The processing circuit 1401 can comprise a fixed-purpose hard-wired platform or can comprise a partially or wholly programmable platform. By one approach, for example, this processing circuit 1401 can comprise a microprocessor or microcontroller. All of these architectural options are well known and understood in the art and require no further description here.

This processing circuit 1401 is configured (for example, via appropriate programming as will be well understood by the art) to carry out one or more of the steps, actions, and functionality as has been set forth herein. This can comprise, for example, providing to the end user information regarding selectable elements of a captured image as a function of relative positions of the selectable elements with respect to one another, receiving that end user's selection of a visual distraction as a selected element to the exclusion of desired target content, accumulating image content from the real-world setting for a portion of the target content as corresponds to the selected element, and aggregating that additional image content with the previously obtained image content for the target content to facilitate the provision of an image of the real-world setting that comprises the target content in the absence of any significant portion of the selected visual distraction.

If desired, this apparatus 1400 can itself further comprise one or more image-capture devices 1404 that are operably coupled to the processing circuit 1401 in order to provide the aforementioned captured image and/or the subsequently accumulated image content. As noted above, this image-capture device 1404 can comprise a depth-imaging platform, such as a stereoscopic platform, that obtains depth information for each pixel that comprises the resultant captured image.

Those skilled in the art will recognize and understand that such an apparatus 1400 may comprise a plurality of physically distinct elements as is suggested by the illustration shown in FIG. 14. It is also possible, however, to view this illustration as comprising a logical view, in which case one or more of these elements can be enabled and realized via a shared platform. It will also be understood that such a shared platform may comprise a wholly or at least partially programmable platform as is known in the art.

Those skilled in the art will appreciate that these teachings provide a highly intuitive yet extremely powerful mechanism by which a relatively unskilled photographer can capture images of desired content that are free from a variety of visual distractions such as sightseeing crowds. These potent benefits are attained in an economical manner and are readily leveraged and scaled to suit a wide variety of implementing platforms and application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, in the examples provided above, the selectable elements are rendered normally while non-selectable elements are rendered in some alternative manner to provide a visual distinction between the two. If desired, this can be reversed, such that the selectable elements are alternatively rendered while the non-selectable elements are shown in a normal format. It would also be possible to render both such elements in a non-normal manner. For example, non-selectable elements can be rendered in a muted fashion while selectable elements are artificially highlighted in some manner to provide an even greater visual differentiation between the two.

We claim:

1. A method comprising:
providing a captured image of a real-world setting, wherein the real-world setting comprises target content and at least one visual distraction;
via a display, providing to an end user information regarding selectable elements of the captured image as a function of relative positions of the selectable elements with respect to one another;
via an end-user interface, receiving an end user's selection of the at least one visual distraction as a selected element, which selection does not include any significant portion of the target content;
subsequent to receiving the end user's selection, accumulating image content from the real-world setting for a portion of the target content as corresponds to the selected element to provide additional image content;
aggregating the additional image content with previously obtained image content for the target content to facilitate provision of an image of the real-world setting that comprises the target content in the absence of the at least one visual distraction.

2. The method of claim 1 wherein the captured image comprises a depth image wherein pixels of the captured image have depth information corresponding thereto.

3. The method of claim 1 wherein the at least one visual distraction comprises at least one real-world object that occludes a portion of the target content.

4. The method of claim 1 wherein providing to an end user information regarding selectable elements of the captured image as a function of relative positions of the selectable elements with respect to one another comprises rendering presently selectable elements of the captured image in a manner that is different from a rendering format that is applied to presently non-selectable elements of the captured image.

5. The method of claim 4 wherein rendering presently selectable elements of the captured image in a manner that is different from a rendering format that is applied to presently non-selectable elements of the captured image comprises:
rendering the presently selectable elements to appear as they appear in the captured image;
using a rendering format for the presently non-selectable elements that is different from a rendering format that is used to render the captured image.

6. The method of claim 5 wherein the rendering format comprises use of a translucent membrane.

7. The method of claim 1 wherein accumulating image content from the real-world setting for a portion of the target content as corresponds to the selected element to provide additional image content comprises capturing image content from at least two different relative physical arrangements of at least one of an image-capture platform as is used to capture the image of the real-world setting, the target content, and the at least one visual distraction.

8. The method of claim 1 further comprising:
providing an indication to the end user regarding when the step of aggregating the additional image content with previously obtained image content for the target content is completed.

9. The method of claim 1 wherein aggregating the additional image content with previously obtained image content for the target content to facilitate the provision of an image of the real-world setting that comprises the target content in the absence of the at least one visual distraction comprises:
displaying a present aggregation result that does not comprise a complete result for the target content while accumulating the image content from the real-world setting for the portion of the target content as corresponds to the selected element.

10. The method of claim 9 wherein aggregating the additional image content with previously obtained image content for the target content to facilitate the provision of an image of the real-world setting that comprises the target content in the absence of the at least one visual distraction comprises:
providing the end user with an opportunity to accept the present aggregation result and to terminate further accumulation of the image content from the real-world setting for the portion of the target content as corresponds to the selected element.

11. The method of claim 10 wherein providing the end user with an opportunity to accept the present aggregation result and to terminate further accumulation of the image content from the real-world setting for the portion of the target content as corresponds to the selected element comprises:
displaying a present aggregation result that also includes interpolated content to substitute for presently uncaptured image content from the real-world setting for the portion of the target content as corresponds to the selected element.

12. The method of claim 1 further comprising:
via the end-user interface, receiving an end user's separate selection of at least one object in the captured image as segregated content to be retained;
and wherein aggregating the additional image content with previously obtained image content for the target content to facilitate the provision of an image of the real-world setting that comprises the target content in the absence of the at least one visual distraction comprises:
combining the segregated content to be retained with the image of the real-world setting that comprises the target content in the absence of the at least one visual distraction.

13. The method of claim 12 wherein the target content comprises background content, the segregated content to be retained comprises foreground content, and the at least one visual distraction comprises midground content.

14. An apparatus comprising:
a memory that is configured to store therein a captured image of a real-world setting, wherein the real-world setting comprises target content and at least one visual distraction;
a display;
an end-user interface;
a processing circuit operably coupled to the memory, the display, and the end-user interface and being configured to:
via the display, provide to an end user information regarding selectable elements of the captured image as a function of relative positions of the selectable elements with respect to one another;
via the end-user interface, receive an end user's selection of the at least one visual distraction as a selected element, which selection does not include any significant portion of the target content;
subsequent to receiving the end user's selection, accumulate image content from the real-world setting for a portion of the target content as corresponds to the selected element to provide additional image content;
aggregate the additional image content with previously obtained image content for the target content to facilitate provision of an image of the real-world setting that comprises the target content in the absence of the at least one visual distraction.

15. The apparatus of claim 14 wherein the processing circuit is configured to provide to an end user information regarding selectable elements of the captured image as a function of relative positions of the selectable elements with respect to one another by rendering presently selectable elements of the captured image in a manner that is different from a rendering format that is applied to presently non-selectable elements of the captured image.

16. The apparatus of claim 15 wherein the processing circuit is configured to render presently selectable elements of the captured image in a manner that is different from a rendering format that is applied to presently non-selectable elements of the captured image by:
rendering the presently selectable elements to appear as they appear in the captured image;
using a rendering format for the presently non-selectable elements that is different from a rendering format that is used to render the captured image.

17. The apparatus of claim 14 wherein the processing circuit is further configured to:
provide an indication to the end user regarding when the step of aggregating the additional image content with previously obtained image content for the target content is completed.

18. The apparatus of claim 14 wherein the processing circuit is further configured to aggregate the additional image content with previously obtained image content for the target content to facilitate the provision of an image of the real-world setting that comprises the target content in the absence of the at least one visual distraction by:
displaying a present aggregation result that does not comprise a complete result for the target content while accumulating the image content from the real-world setting for the portion of the target content as corresponds to the selected element.

19. The apparatus of claim 18 wherein the processing circuit is further configured to aggregate the additional image content with previously obtained image content for the target content to facilitate the provision of an image of the real-world setting that comprises the target content in the absence of the at least one visual distraction by:
providing the end user with an opportunity to accept the present aggregation result and to terminate further accumulation of the image content from the real-world setting for the portion of the target content as corresponds to the selected element.

20. The apparatus of claim 19 wherein the processing circuit is further configured to provide the end user with an opportunity to accept the present aggregation result and to terminate further accumulation of the image content from the real-world setting for the portion of the target content as corresponds to the selected element by:
displaying a present aggregation result that also includes interpolated content to substitute for presently uncaptured image content from the real-world setting for the portion of the target content as corresponds to the selected element.
